(19) United States
(12) Patent Application Publication
(10) Pub. No.: US 2017/0041606 A1
(43) Pub. Date: Feb. 9, 2017

(54) VIDEO ENCODING DEVICE AND VIDEO ENCODING METHOD

(71) Applicant: FUJITSU LIMITED, Kawasaki-shi (JP)

(72) Inventor: Hidetoshi Matsumura, Kawasaki (JP)

(73) Assignee: FUJITSU LIMITED, Kawasaki-shi (JP)

(21) Appl. No.: 15/224,508

(22) Filed: Jul. 29, 2016

(30) Foreign Application Priority Data
Aug. 4, 2015 (JP) 2015-154159

(51) Int. Cl. H04N 19/119; H04N 19/13; H04N 19/527; H04N 19/176; H04N 19/61; H04N 19/159; H04N 19/117; H04N 19/172

(52) U.S. Cl. CPC H04N 19/119; H04N 19/117; H04N 19/13; H04N 19/172; H04N 19/176; H04N 19/61; H04N 19/159; H04N 19/527

(57) ABSTRACT

A video encoding device includes: a first encoder which calculates, for each block obtained by dividing a picture, an evaluation value representing amount of a prediction error based on any of at least one first coding mode on which a first reference range is referenced, and performs predictive coding on any block according to any of the first coding mode to calculate encoded data of the block; a second encoder which performs predictive coding on any of blocks according to any of the at least one second coding mode on which a second reference range larger than the first reference range is referenced, to calculate encoded data of the block and; a determinator which determines a block to be encoded by the second encoder, based on the evaluation value for each block; and an entropy encoder which entropy encodes the encoded data of each block.

### CROSS-REFERENCE TO RELATED APPLICATION

This application is based upon and claims the benefit of priority of the prior Japanese Patent Application No. 2015-154159, filed on Aug. 4, 2015, and the entire contents of which are incorporated herein by reference.

### FIELD

The embodiments discussed herein are related to a video encoding device and a video encoding method.

### BACKGROUND

Video data generally includes a very large amount of data. Thus, an apparatus which deals with video data compresses the video data by encoding the video data when transmitting the video data to another apparatus or storing the video data in a storage apparatus. As typical coding scheme for videos, Moving Picture Experts Group phase 2 (MPEG-2), MPEG-4, or H.264 MPEG-4 Advanced Video Coding (H. 264 MPEG-4 AVC) defined by International Standardization Organization/International Electrotechnical Commission (ISO/IEC) is widely utilized.

Such a video coding scheme implements compression processing by combining, for each block obtained by dividing a picture, prediction coding, transform coding, entropy encoding, or the like. Therefore, a calculation amount for coding video data is excessive, and as a result, power consumption of a video encoding device executing video encoding also increases. Note that prediction coding is coding processing which obtains a prediction block of a target block and calculates the difference between the corresponding pixels in the target block and the prediction block, as a prediction error signal. Transformation coding is coding processing which quantizes an orthogonal transform coefficient obtained by performing orthogonal transform, such as a discrete cosine transform (DCT), on a signal (for example, the prediction error signal) which is a coding target of a target block to calculate a quantization coefficient. Entropy coding is processing which encodes a quantization coefficient or the like utilizing variable-length codes, such as Huffman code or an arithmetic code.

In such a video coding scheme, a plurality of coding modes for specifying coding scheme for each block, such as a prediction block generation method, are prepared. The video encoding device selects a coding mode with the minimum coding cost from the plurality of coding modes for each block, and applies the selected coding mode to the block. The video encoding device executes very large amount of calculations to select coding modes, and this leads a relatively large amount of power consumption for the selection of the coding modes. In particular, High Efficiency Video Coding (HEVC) cooperatively standardized by ISO/IEC and ITU-T achieves a compression efficiency approximately twice of that in H. 264/MPEG-4 AVC, but the amount of calculations and the electric energy for encoding video data increases further, in comparison with H. 264/MPEG-4 AVC.

In view of this, a technique for suppressing power consumption when video data is encoded has been proposed (e.g. refer to Japanese Laid-open Patent Publication No. 2008-78969). The video encoding recorder disclosed in Japanese Laid-open Patent Publication No. 2008-78969 performs intra-prediction coding in all block size without limiting the block size when intra-prediction is applied in a normal mode. On the other hand, when a power-saving mode is set, the video encoding recorder limits a block size in the intra prediction compared with the normal mode, and performs intra-prediction coding.

### SUMMARY

However, in the technique disclosed in Japanese Laid-open Patent Publication No. 2008-78969, usable block size is limited when the power-saving mode is set. In this case, the optimal block size may not be applied, which may result in a drop in encoding efficiency.

According to an exemplary embodiment, the video encoding device which encodes a picture included in video is provided. The video encoding device includes: a divider configured to divide the picture into a plurality of blocks; a first encoder configured to calculate, for each of the plurality of blocks, an evaluation value representing amount of a prediction error in the predictive coding based on any of at least one first coding mode on which a first reference range in a reference picture previous to the picture in the coding order or an encoded reference area in the picture is referenced, and perform predictive coding on any block of the plurality of blocks according to any of the at least one first coding mode to calculate encoded data of the block; a second encoder configured to perform predictive coding on any block of the plurality of blocks according to any of the at least one second coding mode on which a second reference range in the reference picture or the reference area is referenced, to calculate encoded data of the block, the second reference range being larger than the first reference range and; a determinator configured to determine a block on which predictive coding is to be performed by the second encoder among the plurality of blocks, based on the evaluation value for each of the plurality of blocks; and an entropy encoder configured to perform entropy encoding on the encoded data of each of the plurality of blocks.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of a video encoding device according to an embodiment.

FIG. 2 is a diagram illustrating an example of a picture division structure based on HEVC.

FIG. 3 is a diagram illustrating an example of an area which is a target of in-loop filtering by an encoder.

FIG. 4 is a diagram illustrating an example of a relationship between a coding-target block of the encoder and a prediction mode the use of which is restricted in a simple encoder.

FIG. 5 is an operation flowchart of a coding-target determination process.

FIG. 6 is an operation flowchart of video coding.

FIG. 7 is a schematic configuration diagram of a video encoding device according to a modified example.

FIG. 8 is a chart illustrating an example of a timing chart representing target pictures to be processed by each unit when the video encoding device according to the modified example encodes a plurality of video data streams in parallel.

### DESCRIPTION OF EMBODIMENTS

A video encoding device according to an embodiment is described below with reference to the drawings. The video encoding device includes an encoder and a simple encoder. A reference range of the encoder is larger than that of the simple encoder, the reference range being set for another picture that has been already encoded or an encoded area in a coding-target picture, when a usable coding mode for a target block of the coding-target picture is determined. The video encoding device uses the encoder to perform predictive coding on each block having a coding cost calculated by the simple encoder larger than or equal to a predetermined threshold value among the multiple blocks obtained by dividing the picture, and uses the simple encoder to perform predictive coding on the other blocks. With this configuration, the video encoding device suppresses a decrease in coding efficiency while reducing the computation amount for selecting a coding mode and thereby reducing power consumption.

The video encoding device according to this embodiment encodes each picture included in a video in accordance with a video coding scheme based on HEVC. Each picture may be either a frame or a field. A frame is a single still image of video data, whereas a field is a still image obtained by extracting only data of odd rows or data of even rows from a frame.

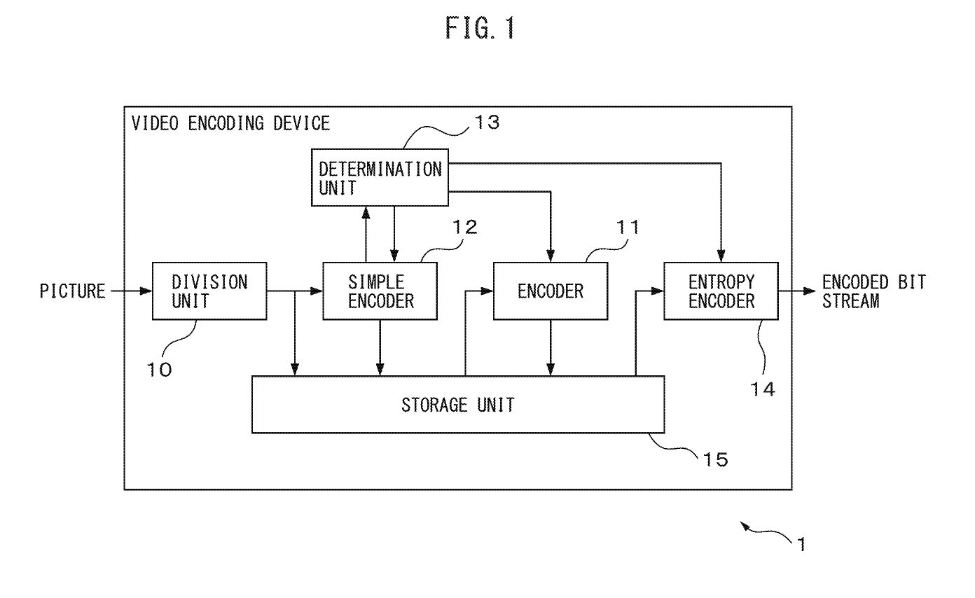

FIG. 1 is a schematic configuration diagram of a video encoding device according to an embodiment. A video encoding device 1 includes a division unit 10, an encoder 11, a simple encoder 12, a determination unit 13, an entropy encoder 14, and a storage unit 15. These units included in the video encoding device 1 are formed as separate circuits. Alternatively, these units included in the video encoding device 1 may be mounted in the video encoding device 1 as a single or multiple integrated circuits into which circuits corresponding to the units are integrated. For example, an integrated circuit with the function of the storage unit 15 and an integrated circuit with the functions of the division unit 10, the encoder 11, the simple encoder 12, the determination unit 13, and the entropy encoder 14, may be formed separately. The storage unit 15 may include a first memory circuit configured to store each picture that is encoded once and then decoded (referred to as a locally decoded picture), and a second memory circuit configured to store information other than the picture. The second memory circuit may be formed integrally with an integrated circuit with the functions of the division unit 10, the encoder 11, the simple encoder 12, the determination unit 13, and the entropy encoder 14, whereas the first memory circuit may be provided separately from the integrated circuit. Further, integrated circuits with these functions may be mounted in, for example, a processor, a numerical data processor, or a graphics processing unit (GPU).

Pictures are sequentially input to the division unit 10 according to a coding order for pictures set by a control unit (not illustrated) configured to control the entire video encoding device 1. Every time a picture is input, the division unit 10 divides the picture into multiple blocks. In this embodiment, each block corresponds to coding tree unit (CTU). The division unit 10 sequentially outputs the blocks to the encoder 11 according to the raster scan order and stores the blocks in the storage unit 15.

The encoder 11 performs predictive coding on each block determined by the determination unit 13, to be a coding target of the encoder 11 among the input blocks. In this coding, the encoder 11 selects a coding mode to be employed from among all usable coding modes for the coding-target picture. The encoder 11 uses a relatively large reference range set for another picture that has already been encoded or an encoded area of the coding-target picture, in comparison with the simple encoder 12. The encoder 11 performs predictive coding on the block in the selected coding mode to thereby obtain encoded data of the block. The encoded data includes information such as quantized coefficients obtained by quantizing orthogonal-transform coefficients obtained by performing an orthogonal transform on a prediction error signal between the coding-target block and a predicted block, a motion vector, and the employed coding mode. The encoder 11 stores the encoded data of the block in the storage unit 15.

Blocks are sequentially input to the simple encoder 12 in the raster scan order. Every time a block is input, the simple encoder 12 performs predictive coding on the block. In the coding, the simple encoder 12 selects a coding mode to employ from among at least one coding mode set in advance so that the simple encoder 12 can use among the multiple usable coding modes for the coding-target picture. The number of coding modes that the simple encoder 12 can employ may be smaller than the number of coding modes that the encoder 11 can employ. The simple encoder 12 performs predictive coding on the block in the selected coding mode to thereby obtain the encoded data of the block.

Every time the simple encoder 12 obtains encoded data of an input block, the simple encoder 12 stores the encoded data in the storage unit 15. In addition, every time the simple encoder 12 obtains encoded data of an input block, the simple encoder 12 outputs, to the determination unit 13, a coding cost corresponding to the coding mode employed in the predictive coding of the block. The coding cost is an example of an evaluation value representing the amount of a prediction error in the predictive coding of the block.

Every time the determination unit 13 receives the coding cost of a block from the simple encoder 12, the determination unit 13 determines whether the block is to be a coding target of the encoder 11, on the basis of the coding cost. Then, the determination unit 13 notifies the encoder 11, the simple encoder 12, and the entropy encoder 14 of the determination result.

The entropy encoder 14 performs entropy encoding on the encoded data of the blocks in the raster scan order. In the encoding, for each block to be a coding target of the encoder 11, the entropy encoder 14 performs entropy encoding on the encoded data obtained by the encoder 11. In contrast, for each block that is not a coding target of the encoder 11, the entropy encoder 14 performs entropy encoding on the encoded data obtained by the simple encoder 12.

Moreover, for each block for which the encoder 11 or the simple encoder 12 employed the inter-prediction coding mode as a coding mode, the entropy encoder 14 determines a prediction vector of a motion vector used for the block, according to HEVC. The entropy encoder 14 includes information identifying the prediction vector and, when needed, the prediction error between the motion vector and the prediction vector, into the encoded data on which entropy encoding is to be performed. Note that the inter-prediction coding mode is a coding mode in which a coding-target block of a coding-target picture is encoded by the use of information on other encoded pictures.

The entropy encoder 14 combines the encoded data of the blocks on which entropy encoding is performed, in the raster scan order, and adds certain header information to the resultant, thereby generating a bit stream including the encoded data of the entire picture. The bit streams of the encoded data of the respective pictures are further combined by a multiplexing unit (not illustrated) in the order of the coding of the pictures, and certain header information is added to the resultant. In this way, a bit stream including the encoded video data is generated.

The storage unit 15 temporarily stores the pictures input in the coding order. In addition, the storage unit 15 stores locally decoded blocks each of which is generated by the encoder 11 or the simple encoder 12 and is encoded once and then decoded. A locally decoded picture is obtained by combining locally decoded blocks corresponding to a single picture.

Further, the storage unit 15 stores encoded data of each block and the like generated by the encoder 11 or the simple encoder 12.

Details of each unit of the video encoding device 1 are described below.

The encoder 11 performs predictive coding on each block determined to be a coding target by the determination unit 13.

In this embodiment, the video encoding device 1 encodes each picture according to HEVC. For this reason, each block may correspond to a CTU as described above. Description is hence given below of a CTU structure.

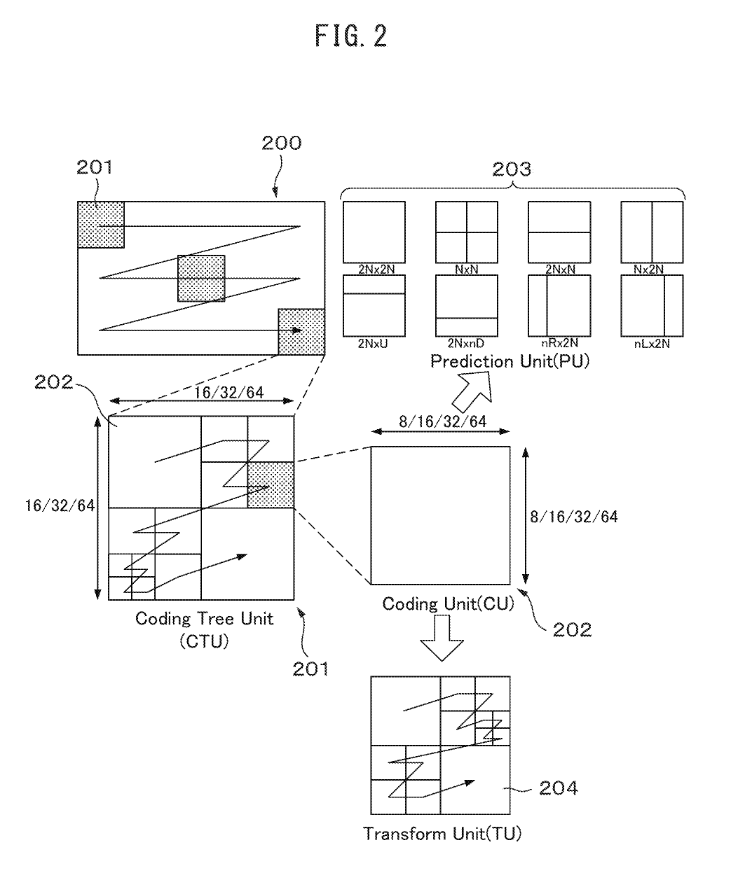

FIG. 2 is a diagram illustrating an example of a picture division structure based on HEVC. As illustrated in FIG. 2, a picture 200 is divided into CTUs. The size of each CTU 201 can be selected from the range of 64 pixels by 64 pixels to 16 pixels by 16 pixels. Note that the size of the CTUs 201 in each sequence are set to be the same.

The CTU 201 is further divided into multiple coding units (CUs) 202 according to the quadtree structure. The CUs 202 in each CTU 201 are encoded in the z-scan order. The size of each CU 202 is variable and is selected from among CU dividing modes corresponding to the range of 8 pixels by 8 pixels to 64 pixels by 64 pixels. Each CU 202 serves as unit for selecting between the intra-prediction coding mode and the inter-prediction coding mode. The intra-prediction coding mode is a coding mode in which a coding-target block is encoded by the use of information on encoded areas of the coding-target picture. On the other hand, the inter-prediction coding mode is a coding mode in which a coding-target block of a coding-target picture is encoded by the use of information on other already encoded pictures. The CUs 202 are processed separately for each prediction unit (PU) 203 or each transform unit (TU) 204. Each PU 203 is a unit for performing prediction according to a coding mode. For example, each PU 203 serves as a unit for which a prediction mode defining pixels to be referred to for generating a prediction block and a method of calculating the value of each pixel of the prediction block is used, in the intra-prediction coding mode, and serves as a unit for which motion compensation is performed, in the inter-prediction coding mode. The size of each PU 203 may be selected, for example, from among PU division modes PartMode=2N×2N, N×N, 2N×N, N×2N, 2N×U, 2N×nD, nR×2N, and nL×2N in the inter-prediction coding. Each TU 204 is a unit of orthogonal transform, and the size of each TU 204 is selected from the range of 4 pixels by 4 pixels to 32 pixels by 32 pixels. Each TU 204 is divided according to the quadtree structure, and the obtained units are processed in the z-scan order.

The encoder 11 calculates a coding cost, which is an estimation value of the amount of encoded data of the coding-target block, for each combination of the usable CU, PU, and TU sizes and a usable coding mode. For example, the encoder 11 calculates a coding cost for each combination of CU, PU, and TU into which the coding-target block CTU is divided, for the inter-prediction coding mode. In the calculation, the encoder 11 performs, on each PU, block matching between the PU and each locally decoded picture. The encoder 11 determines, for each PU, the locally decoded picture that is the best match with the PU and the position of the PU in the locally decoded picture, to thereby obtain a motion vector.

For the intra-prediction coding mode, the encoder 11 calculates the coding cost of each possible combination of CU, PU, and TU, for each prediction mode.

For example, in order to calculate the coding cost of a target combination, the encoder 11 calculates SAD, the sum of absolute values of the pixel differences, for each TU included in the combination in accordance with the following equation.

SAD=Σ|OrgPixel−PredPixel|

Wherein, OrgPixel denotes the value of a pixel in the coding-target block, and PredPixel denotes the value of a corresponding pixel included in the prediction block.

The encoder 11 calculates a coding cost Cost for the target combination in accordance with the following equation.

Cost=ΣSAD+λR

Wherein, ΣSAD is the total of SADs calculated for the respective TUs included in the coding-target block, i.e., CTU. R denotes an estimation value of a coding amount for an item for identifying a coding mode other than an orthogonal transform coefficient, such as a flag indicating the prediction mode, and λ is a constant.

The encoder 11 may calculate SATD, the sum of the absolute values of the Hadamard transform result on the difference image between the target block and the prediction block and so on, instead of SAD.

The encoder 11 selects a coding mode to employ from the intra-prediction coding mode and the inter-prediction coding mode for each CU of the coding-target block so that the coding cost is to be the lowest. In addition, the encoder 11 selects a coding mode for each combination of PU and TU in each CU so that the coding cost is to be the lowest. Then, the encoder 11 determines the combination of CUs, PUs, and TUs and a coding mode that results in the lowest coding cost, to be the combination to use for the coding-target block.

The encoder 11 divides a CTU which is the coding-target block into each CU according to the combination of CU, PU, and TU to use. Then, the encoder 11 generates, for each CU of the coding-target block, a prediction block of each PU in the CU in the coding mode to employ. When inter-prediction coding is performed on the target CU, the encoder 11 generates, for each PU in the CU, a prediction block by performing motion compensation on the reference area in the locally decoded picture indicated by the motion vector obtained for the PU.

When the intra-prediction coding is performed on the target CU, the encoder 11 generates, for each PU included in the CU, a prediction block on the basis of the pixels adjacent to the PU in the prediction mode to employ.

The encoder 11 performs, for each CU, difference operation on each PU included in the CU and the corresponding prediction block. The encoder 11 then obtains, as a prediction error signal, the difference value corresponding to each pixel in the PU obtained by the difference operation.

The encoder 11 performs, for each CU of the coding-target block, transform coding on the prediction error signals. Specifically, the encoder 11 obtains an orthogonal coefficient by performing, for each CU, orthogonal transform on each TU included in the CU. For example, the encoder 11 performs discrete cosine transform (DCT), as orthogonal transform, on the prediction error signals to thereby obtain a set of DCT coefficients for each TU, as an orthogonal-transform coefficient.

Subsequently, the encoder 11 quantizes the orthogonal-transform coefficient to calculate a quantization coefficient for the orthogonal-transform coefficient. This quantization is a process for expressing signal values included in a certain range, by a single signal value, which is referred to as a quantization step. For example, the encoder 11 quantizes the orthogonal-transform coefficient by rounding down a predetermined number of low-order bits corresponding to the quantization step from the orthogonal-transform coefficient. The quantization step is determined according to a quantization parameter. For example, the encoder 11 determines a quantization step to use, according to the function indicating the value of the quantization step with respect to the quantization parameter value. The function may be a monotonously increasing function with respect to the quantization parameter value and is set in advance.

Alternatively, multiple quantization matrices defining quantization steps corresponding to the respective horizontal components and vertical components of orthogonal-transform coefficients are prepared in advance and stored in the memory included in the encoder 11. The encoder 11 selects a certain one of the quantization matrices according to the quantization parameter. The encoder 11 may then determine a quantization step for each orthogonal-transform coefficient with reference to the selected quantization matrix.

The encoder 11 may determine a quantization parameter in any of various methods of determining a quantization parameter that are based on a video coding standard, such as HEVC. The encoder 11 may use, for example, a method of calculating a quantization parameter for MPEG-2 standard Test Model 5. Regarding the method of calculating a quantization parameter for MPEG-2 standard Test Model 5, refer to the website specified by the uniform resource locator (URL) http://www.mpeg.org/MPEG/MSSG/tm5/Ch10/Ch10.html, for example.

On the basis of the quantization coefficients of the TUs in the coding-target block, the encoder 11 decodes the block to obtain a locally decoded block. The decoded block is referred to for encoding blocks subsequent to the block. For the decoding, the encoder 11 performs inverse quantization on the quantized coefficient by multiplying the quantized coefficient by a predetermined number corresponding to the quantization step determined according to the quantization parameter. Through this inverse quantization, the orthogonal-transform coefficient, e.g., the set of DCT coefficients, of each TU in the coding-target block is restored. Then, the encoder 11 performs an inverse orthogonal transform on the restored orthogonal-transform coefficient of each TU. For example, when the encoder 11 calculated each orthogonal-transform coefficient by the use of DCT, the encoder 11 performs inverse DCT on the restored orthogonal-transform coefficient. By performing inverse quantization and inverse orthogonal transform on each quantized signal, a prediction error signal corresponding to the prediction error signal before the coding is reproduced.

The encoder 11 adds, to the value of each pixel in the prediction block, the reproduced prediction error signal corresponding to the pixel. By carrying out these processes for each PU, the encoder 11 generates a locally decoded block.

The encoder 11 may further perform in-loop filtering, such as deblocking filtering or sample adaptive offset (SAO), on each locally decoded block.

In some cases, deblocking filtering is performed on the boundary between a block encoded by the simple encoder 12 and a block encoded by the encoder 11. In this case, the value of each corresponding pixel in the block encoded by the simple encoder 12 is replaced by referring to the value of the corresponding pixel in the block encoded by the encoder 11. The encoder 11 also performs deblocking filtering on a part including the boundary between a block encoded by the simple encoder 12 and a block encoded by the encoder 11 as well as the TU boundaries and PU boundaries in the coding-target block. The encoder 11 also performs SAO on each pixel the value of which is replaced by deblocking performed by the encoder 11, among the pixels in the block encoded by the simple encoder 12.

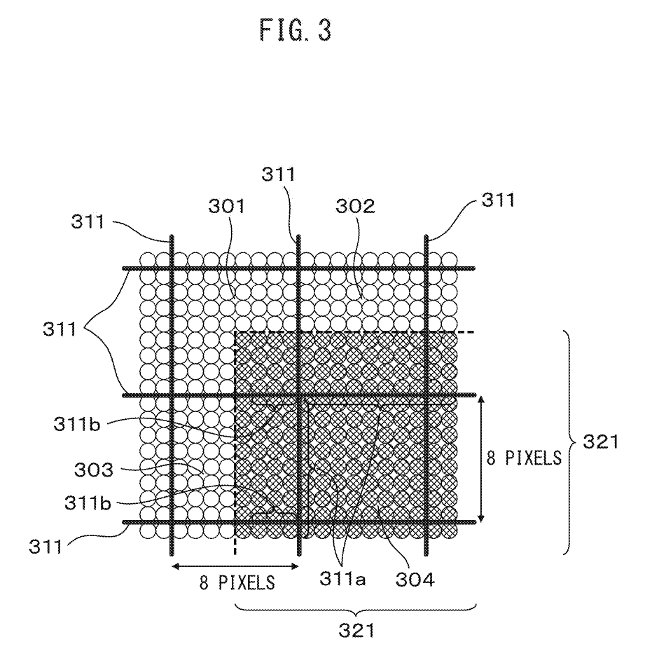

FIG. 3 is a diagram illustrating an example of an area which is a target of in-loop filtering by the encoder 11. In FIG. 3, blocks 301 to 303 are locally decoded blocks obtained by the simple encoder 12, and a block 304 is a locally decoded block obtained by the encoder 11.

In HEVC, a deblocking process is performed on the boundaries between TUs which are larger than 8 pixels by 8 pixels and the boundaries between PUs which are larger than 8 pixels by 8 pixels, and the deblocking process is performed independently for each boundary between the blocks since a deblocking filter refers to each four pixels on each side of the boundary. In the deblocking filtering, the values of each three pixels on each side of each boundary are replaced. Deblocking filtering is performed on a vertical boundary first, and deblocking filtering is then performed on a horizontal boundary. Hence, among boundaries 311 between the blocks, the value of each pixel in the locally decoded block 304 is referred to in deblocking filtering performed on boundaries 311a between the block 304 and each of the other blocks. Deblocking filtering performed on boundaries 311b included in the section corresponding to three pixels on the left from the block 304 is affected by the values of the pixels in the locally decoded block 304. For this reason, deblocking filtering is performed on the boundaries 311a and the boundaries 311b by the encoder 11.

In SAO in HEVC, the values of the pixels replaced through deblocking filtering and each 8 pixels around the replaced pixels are replaced. Accordingly, the encoder 11 performs SAO on each pixel in an area 321 having boundaries indicated by dotted lines.

The encoder 11 stores encoded data and locally decoded blocks of the coding-target block in the storage unit 15. The encoder 11 may update the encoded data and locally decoded blocks of the coding-target block written in the storage unit 15 by the simple encoder 12, with the encoded data and locally decoded blocks of the coding-target block obtained by the encoder 11 itself.

The simple encoder 12 performs predictive coding on the blocks (CTUs in this embodiment) obtained by dividing a picture, in the raster scan order. In the coding, the simple encoder 12 selects a coding mode to employ, with reference to a range smaller than that the encoder 11 can refer to. The number of coding modes which the simple encoder 12 can employ may be smaller than the number of coding modes which the encoder 11 can employ. The simple encoder 12 performs predictive coding on each block in the selected coding mode.

In this embodiment, determination is made for each of the blocks whether the block is to be a coding target of the encoder 11, in the raster scan order. Accordingly, when the simple encoder 12 performs predictive coding on a target block, determination is already made for the block adjacent to the left or the upper side of the target block about whether the block is to be a coding target at the encoder 11. For this reason, for example, the simple encoder 12 does not employ any prediction mode in which the pixels in the block determined to be a coding target of the encoder 11 are referred to, in the intra-prediction coding mode. In other words, the number of coding modes that can be employed is reduced, and the reference range referred by the simple encoder 12 becomes narrower, according to the number of prediction modes not to be employed.

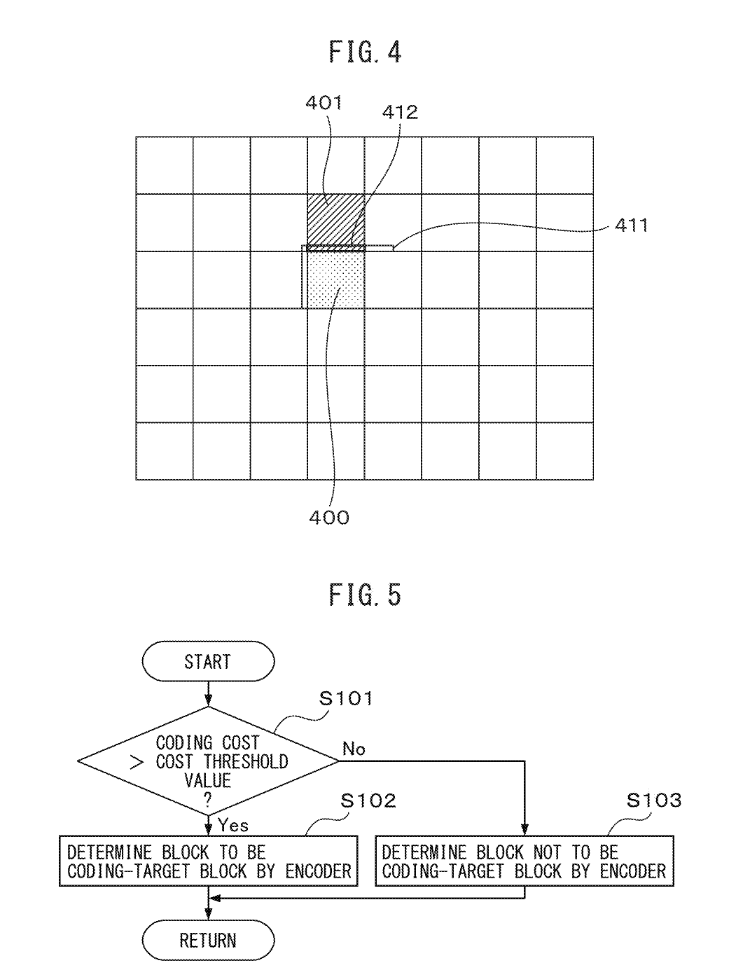

FIG. 4 is a diagram illustrating an example of the relationship between a coding-target block of the encoder 11 and a prediction mode the use of which is restricted in the simple encoder 12. In FIG. 4, a block 400 is a block that is a target of the simple encoder 12. Assume that a block 401, which is adjacent to the upper side of the block 400, is a block encoded by the encoder 11. In this case, the simple encoder 12 prohibits the use of any prediction mode in which the pixels in the block 401 are to be referred to, for each PU adjacent to the upper edge of the block 400. In other words, in the intra-prediction coding mode, pixels to be referred to are selected from among the pixels adjacent to the left side, upper side, or upper right of the PU according to the prediction mode. On the basis of this, in this example, for each PU adjacent to the upper edge of the block 400, the use of a prediction mode is prohibited which refers to pixels 412 included in the block 401 among the pixels included in a range 411, which has the possibility of being referred to in the intra-prediction coding mode.

In the inter-prediction coding mode, the simple encoder 12 may set a narrower reference range on a locally decoded picture than that of the encoder 11 and performs block matching by using the reference range, to search for a motion vector. With this configuration, the computation amount for the motion search by the simple encoder 12 is reduced compared to that for the motion search by the encoder 11.

Alternatively, the simple encoder 12 may perform motion search at an integer pixel accuracy whereas the encoder 11 performs motion search at a fractional pixel accuracy. The number of locally decoded pictures referred to by the simple encoder 12 at the time of motion search may be smaller than that of locally decoded pictures referred to by the encoder 11.

Alternatively, the simple encoder 12 may calculate the coding cost for a predetermined number of motion vectors that are set in advance, without performing motion search. In this case, as the above, the reference range of the simple encoder 12 is narrower than that of the encoder 11, and hence the computation amount is reduced. The predetermined number is set, for example, at any value of one to three. Moreover, a zero vector (a vector having a horizontal component of zero and a vertical component of zero) is used as each motion vector set in advance, for example. Alternatively, the simple encoder 12 may use, as the motion vector set in advance, the motion vector used for the PU at the same position to the coding target block in the picture immediately previous encoded. Alternatively, the simple encoder 12 may use, as each motion vector set in advance, the average vector of the motion vectors used for the PUs in the block adjacent to the left or upper side of the coding-target block.

When the coding cost is equal to or smaller than the value at which the determination unit 13 determines a target block to be a determination target of the encoder 11, the simple encoder 12 may consider all the quantized coefficients to be zero and omit orthogonal transform and quantization.

When performing transform coding on the prediction error signals of a target block, the simple encoder 12 may calculate only orthogonal-transform coefficients each having a predetermined frequency or lower for each TU and sets orthogonal-transform coefficients each having a higher frequency than the predetermined frequency at a predetermined value (e.g., zero). The predetermined frequency may be set at a value corresponding to one fourth to half of the highest frequency of the orthogonal-transform coefficients calculated in the TU, for example.

The simple encoder 12 may set the number of combinations of CU, PU, and TU to calculate the coding cost, to be smaller than the number of combinations of CU, PU, and TU for which the encoder 11 calculates the coding cost. For example, the simple encoder 12 may limit each of PU size and TU size usable for a target block, to a particular size, for example, 8 pixels by 8 pixels or 16 pixels by 16 pixels. Alternatively, the simple encoder 12 may use, for a target block, the combination of CU, PU, and TU used for the block at the same position as the target block in the picture immediately previous to the target picture in the coding order.

When the coding-target picture is a P picture or a B picture, for which the inter-prediction coding mode can be used, the simple encoder 12 does not need to employ the intra-prediction coding mode for the target block. Consequently, the coding-target picture is not referred to, and hence the reference range of the simple encoder 12 results in being narrower than that of the encoder 11. As a result, the computation amount is reduced. Specifically, the simple encoder 12 calculates, for an I picture, for which only the intra-prediction coding mode can be used, the coding cost for each combination of CU, PU, and TU of the target block in each prediction mode under the restrictions on the prediction modes as described above, in each prediction mode. Thereby, the simple encoder 12 obtains the prediction mode and the combination of CU, PU, and TU corresponding to the lowest coding cost. On the other hand, for a P picture or a B picture, the simple encoder 12 calculates the coding cost for each combination of CU, PU, and TU under the above-described restrictions by using the inter-prediction coding mode.

The type (I, P, or B) of the coding-target picture is determined according to the group of pictures (GOP) used for the coding-target video data and the position of the coding-target picture in the order in the GOP.

Alternatively, the simple encoder 12 may be configured to not employ the intra-prediction coding mode for the target block irrespective of the type (I, P, or B) of the coding-target picture. In this case, when the coding-target picture is an I picture, all the blocks in the coding-target picture are coding targets of the encoder 11. On the other hand, when the coding-target picture is a P picture or a B picture, the simple encoder 12 selects a coding mode to be employed, on the basis of the inter-prediction coding mode under the above described restrictions.

When the inter-prediction coding mode is employed for many of the blocks in the picture immediately previous to the coding-target picture in the coding order, it is assumed that the number of CTUs increases in which the coding cost is to be lower by employing the inter-prediction coding mode for the coding-target picture. When the coding-target picture is a P picture or a B picture and the number of blocks including CUs for which the inter-prediction coding mode is employed in the picture immediately previous to the coding-target picture in the coding order is larger than or equal to a predetermined threshold value, the simple encoder 12 does not need to employ the intra-prediction coding mode. The predetermined threshold value is set at a value obtained by multiplying the total number of CTUs set in the picture by a value in the range of 0.5 to 0.9, for example. Alternatively, when the coding-target picture is a P picture or a B picture and the number of pixels in the CUs for which the inter-prediction coding mode is employed in the picture immediately previous to the coding-target picture in the coding order is larger than or equal to a predetermined threshold value, the simple encoder 12 does not need to employ the intra-prediction coding mode. In this case, the predetermined threshold value is set at a value obtained by multiplying the total number of pixels included in the picture by a value in the range of 0.5 to 0.9, for example. With this configuration, the simple encoder 12 can reduce the computation amount for determining a coding mode and also increase the possibility of being able to select a coding mode with high coding efficiency.

The simple encoder 12 may perform in-loop filtering on the PU boundaries and TU boundaries in the target block. Moreover, the simple encoder 12 may perform in-loop filtering on the boundaries between the target block and blocks that are not coding targets of the encoder 11 and are already encoded by the simple encoder 12.

The simple encoder 12 may combine two or more of the above-described various restrictions on the coding modes as long as no confliction occurs.

For the selection of a coding mode and the like, the simple encoder 12 carries out a similar coding process as that of the encoder 11 except for the respect of having restrictions as described above. Hence, for the details of the coding process by the simple encoder 12, refer to the description of the coding process by the encoder 11.

Every time encoded data of a block is generated, the simple encoder 12 writes the encoded data and the locally decoded block of the block to the storage unit 15 and notifies the determination unit 13 of the coding cost corresponding to the coding mode employed for the block.

Every time the determination unit 13 receives the coding cost of a block from the simple encoder 12, the determination unit 13 determines whether the block is to be a coding target of the encoder 11.

FIG. 5 is an operation flowchart of a coding-target determination process carried out by the determination unit 13. The determination unit 13 carries out the coding-target determination process for each block according to this operation flowchart.

The determination unit 13 determines whether the coding cost of a target block is larger than a predetermined cost threshold value (Step S101). When the coding cost is larger than the predetermined cost threshold value (Yes in Step S101), the determination unit 13 set the block to be a coding target of the encoder 11 (Step S102). On the other hand, when the coding cost is smaller than the predetermined cost threshold value (No in Step S101), the determination unit 13 does not set the block to be a coding target of the encoder 11 (Step S103). After Step S102 or Step S103, the determination unit 13 terminates the coding-target determination process.

The determination unit 13 may receive, for each block, ΣSAD of the case with the lowest coding cost, i.e., ΣSAD corresponding to the employed coding mode, as another example of an evaluation value representing the amount of a prediction error, from the simple encoder 12, instead of a coding cost. When ΣSAD is larger than the predetermined cost threshold value, the determination unit 13 may determine the block to be a coding target of the encoder 11. On the other hand, when the coding cost is smaller than the predetermined cost threshold value, the determination unit 13 determines the block that is not to be a coding target of the encoder 11.

The cost threshold value is set, for example, according to desired coding efficiency. For example, the cost threshold value is set at the value corresponding to the highest coding cost when the prediction error for each of all the pixels in the target block is zero.

According to a modified example, the determination unit 13 may dynamically set the cost threshold value. In this case, the determination unit 13 counts, for example, for each of multiple P or B pictures immediately previous to the coding-target picture, the number of blocks determined to be coding targets of the encoder 11. When the average value of the numbers of blocks determined to be coding targets of the encoder 11 is larger than a predetermined count number, the determination unit 13 increases the cost threshold value. In contrast, when the average value of the numbers of blocks set as coding target of the encoder 11 is smaller than the predetermined count number, the determination unit 13 decreases the cost threshold value. With this configuration, the determination unit 13 can set the number of blocks to be coding targets of the encoder 11, within a certain range.

The determination unit 13 notifies the encoder 11, the simple encoder 12, and the entropy encoder 14 of the determination result about whether the block is to be a coding target of the encoder 11.

The entropy encoder 14 determines, for each PU encoded in the inter-prediction coding mode, a prediction vector of the motion vector. For example, the entropy encoder 14 generates a list including candidates for the prediction vector on the basis of the motion vector of the PU adjacent to a predetermined position on the left of or above the target PU and the motion vector of the PU at the same position as the target PU in the previous picture, in a merge mode defined in the HEVC. When one of the candidates for the prediction vector matches the motion vector of the target PU, the entropy encoder 14 determines the matched candidate to be the prediction vector in the merge mode.

The entropy encoder 14 generates a list including the candidates for the prediction vector in an adaptive motion vector prediction (AMVP) mode. In this case, as the above, the entropy encoder 14 determines candidates for the prediction vector with reference to the motion vector of the PU adjacent to a predetermined position on the left of or above the target PU and the motion vector of the PU at the same position as that of the target PU in the previous picture. The entropy encoder 14 determines one of the candidates for the prediction vector having the smallest prediction error with respect to the motion vector of the target PU, to be the prediction vector in the AMVP mode.

The entropy encoder 14 calculates the coding cost for each of the prediction vector in the merge mode and the prediction vector in the AMVP mode. The entropy encoder 14 uses the prediction vector corresponding to the smaller coding cost, as the prediction vector of the target PU. When the prediction vector in the merge mode is used, the entropy encoder 14 obtains an index indicating the position of the prediction vector in the list. The entropy encoder 14 performs entropy encoding on the index. On the other hand, when the prediction vector in the AMVP mode is used, the entropy encoder 14 obtains the index indicating the position of the prediction vector in the list and the prediction error between the prediction vector and the motion vector. The entropy encoder 14 performs entropy encoding on the index and the prediction error.

When the picture including the target PU is a B picture and bidirectional prediction is performed on the PU, the entropy encoder 14 carries out the above process for each of the motion vectors in the L1 direction and the L2 direction.

In addition, the entropy encoder 14 sequentially performs entropy encoding on the encoded data of the blocks stored in the storage unit 15 in the raster scan order. In this embodiment, the entropy encoder 14 employs arithmetic coding, such as context-based adaptive binary arithmetic coding (CABAC), as an entropy coding scheme. As described above, for each block on which prediction coding is performed by the encoder 11, the entropy encoder 14 performs entropy encoding on the encoded data obtained by the encoder 11. For each of the other blocks, on the other hand, the entropy encoder 14 performs entropy encoding on the encoded data obtained by the simple encoder 12.

When the encoded data of all the blocks in the coding-target picture are calculated by the simple encoder 12 and the encoder 11, the entropy encoder 14 sequentially performs entropy encoding on the blocks from the one at the upper left edge. Alternatively, every time the encoder 11 encodes the block determined to be a coding target of the encoder 11 by the determination unit 13, the entropy encoder 14 may perform entropy encoding on the blocks up to the coding-target block.

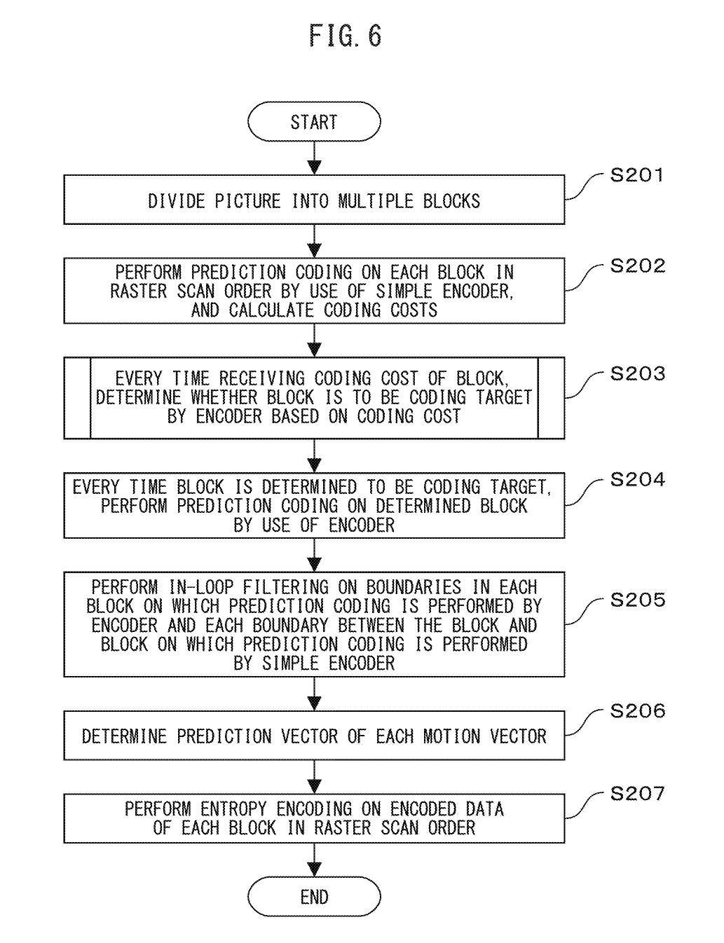

FIG. 6 is an operation flowchart of the video coding by the video encoding device 1. The video encoding device 1 encodes each picture according to the following operation flowchart.

The division unit 10 divides the coding-target picture into multiple blocks (Step S201). The division unit 10 outputs the blocks in the raster scan order to the simple encoder 12 and stores the blocks in the storage unit 15. Every time one of the blocks is input in the raster scan order, the simple encoder 12 calculates the coding cost for each coding mode with reference to the reference range smaller than that of the encoder 11, and selects a coding mode to be employed so that the coding cost is to be the smallest. The simple encoder 12 performs prediction coding on the block by the use of the selected coding mode (Step S202). Every time coding is completed, the simple encoder 12 stores the encoded data of the block in the storage unit 15 and passes the coding cost corresponding to the employed coding mode to the determination unit 13.

Every time the determination unit 13 receives the coding cost of one of the blocks from the simple encoder 12, the determination unit 13 determines whether the block is to be a coding target of the encoder 11, on the basis of the coding cost (Step S203). The determination unit 13 notifies the encoder 11, the simple encoder 12, and the entropy encoder 14 of the determination result.

The encoder 11 performs prediction coding on each block determined to be a coding target by the determination unit 13 among the blocks set in the coding-target picture (Step S204). In the prediction coding, the encoder 11 selects a coding mode to employ, by referring to the reference range larger than that of the simple encoder 12 and performs prediction coding on the block by employing the selected coding mode. The encoder 11 then stores the encoded data of the block in the storage unit 15. In addition, the encoder 11 performs in-loop filtering on the boundaries between adjacent blocks as well as the boundaries between TUs or PUs in the coding-target block (Step S205).

The entropy encoder 14 determines, for each block including PU on which an inter-prediction coding is performed, a prediction vector of the motion vector of the PU (Step S206). The entropy encoder 14 adds information specifying the prediction vector and, when needed, the prediction error between the prediction vector and the motion vector, to the encoded data of the block. The entropy encoder 14 further performs entropy encoding on the encoded data of the blocks in the raster scan order (Step S207). The video encoding device 1 terminates the video coding.

Next, description is given of comparison between power consumption by the video encoding device according to this embodiment and power consumption by a video encoding device configured to reduce power consumption by the use of clock gating or hierarchy coding, as a comparison example.

Power consumption P per picture by the video encoding device 1 according to this embodiment is expressed, for example, by the following equation.

P=LM+N

Wherein, M denotes the total number of blocks included in a picture. N corresponds to the number of coding-target blocks of the encoder 11. L denotes the power consumption for a single block by the simple encoder 12 when the power consumption for a single block by the encoder 11 is assumed to be one. For example, when the number of the coding costs calculated by the simple encoder 12 is one tenth of the number of coding costs calculated by the encoder 11, L is approximately 0.1.

On the other hand, when clock gating is used, the video encoding device encodes each block by the use of an encoder that can employ any of all coding modes, while attempting to reduce power consumption by stopping the supply of a clock signal to a circuit corresponding to a process terminated at an early stage in the encoder. In this case, power consumption P1 per picture is expressed, for example, by the following equation.

P1=G(M−N)+N

Wherein, N represents the number of blocks for which the supply of a clock signal is not stopped, the blocks corresponding to the coding-target blocks of the encoder 11 in this embodiment. G denotes power consumption for a block for which the supply of a clock signal is stopped. When it is assumed that the power consumption of the coding of a single block in the case where the supply of a clock signal is not stopped, i.e., the encoder fully operates, is one, G usually corresponds to a value in the range of approximately 0.8 to 0.9. Accordingly, the difference between the power consumption P per picture by the video encoding device 1 according to this embodiment and the power consumption P1 per picture according to this comparison example is expressed as the following equation.

P1−P=GM−GN−LM=(G−L)M−GN

As described above, when it is assumed that G=0.8 to 0.9 and L=0.1, and N is half of M or smaller, (P1−P) is positive. Hence, the video encoding device according to this embodiment can reduce power consumption more than that in the comparison example.

When hierarchy coding is employed, the video encoding device divides a reduced picture obtained by down-sampling a picture, into sub-blocks corresponding to blocks, and selects candidates for a coding mode to employ for each sub-block. The video encoding device selects, for each block, a coding mode to employ from among the candidates obtained for the corresponding sub-block. In this case, power consumption P2 per picture is expressed, for example, by the following equation.

P2=RM+OM

Wherein, R denotes power consumption for the process to be performed on a single sub-block in the reduced picture. O denotes power consumption for the process to be performed on a single block in the picture. In this case, when it is assumed that power consumption for a single block in the case of selecting a coding mode to employ from among all the coding modes without using any reduced picture is one, R and O are R=0.1 to 0.3 and O=0.2 to 0.3, approximately. The difference between the power consumption P per picture by the video encoding device 1 according to this embodiment and the power consumption P2 per picture according to this comparison example is expressed by the following equation.

P2−P=(R+O−L)M−N

Hence, when the difference between O and L is not large and N is approximately a fraction of M or smaller, (P2−P) is positive. In addition, the larger O is than L, the larger N may result in (P2−P) being positive. This means that the video encoding device according to this embodiment can reduce power consumption more than that in the comparison example.

As described above, this video encoding device includes an encoder that can employ any of all coding modes usable for pictures and a simple encoder having a reference range to refer to for determining a coding mode, smaller than that of the encoder. This video encoding device performs prediction coding on each block having a coding cost by the simple encoder smaller than or equal to a predetermined cost threshold value among multiple blocks obtained by dividing a picture, by the use of the simple encoder. Therefore, the video encoding device can reduce the computation amount for determining a coding mode that can be used, in comparison with the case of performing prediction coding on all the blocks by the use of the encoder. Hence, with this video encoding device, it is possible to reduce power consumption. Moreover, since this video encoding device performs, by the use of the encoder, prediction coding on each block having a coding cost of the simple encoder larger than the predetermined cost threshold value, the possibility of being able to employ a more appropriate coding mode for such a block increases. Hence, with this video encoding device, reduction of coding efficiency can be prevented. In particular, when coding-target video data is video data including no motion or including motion in only part of a picture, such as a video by a security camera, most of the blocks can be processed by the simple encoder. Hence, this video encoding device can more efficiently reduce power consumption for such video data.

According to a modified example, the simple encoder 12 may perform only the calculation of the smallest coding cost for each block. The determination unit 13 may perform prediction coding on each block determined not to be a coding target of the encoder 11. In this case, the processes such as the calculation of a prediction error signal, orthogonal transform, and quantization by the simple encoder 12 for each coding-target block of the encoder 11 are omitted, and hence the video encoding device can further reduce power consumption.

According to another modified example, the encoder 11 may determine a prediction vector of the motion vector of each PU for which the inter-prediction coding mode is employed for each block encoded by the encoder 11. In this case, the encoder 11 may determine a prediction vector by carrying out a process similar to the above-described process of determining a prediction vector by the entropy encoder 14. Alternatively, for the determination of a coding mode to be applied, the encoder 11 may calculate the coding cost for each coding mode by the use of the prediction vector. The encoder 11 may further include, in the encoded data of the block, the index indicating the position of the prediction vector in the list and a flag indicating the mode (merge mode or AMVP mode) used for the calculation of the prediction vector. Similarly, the encoder 11 may determine, for each block encoded by the simple encoder 12 and including a CU for which the inter-prediction coding mode is used, the prediction vector of the motion vector of each PU in the CU.

This video encoding device is also applicable to a system desired to encode a plurality of video data streams in parallel, such as a virtual desktop infrastructure (VDI).

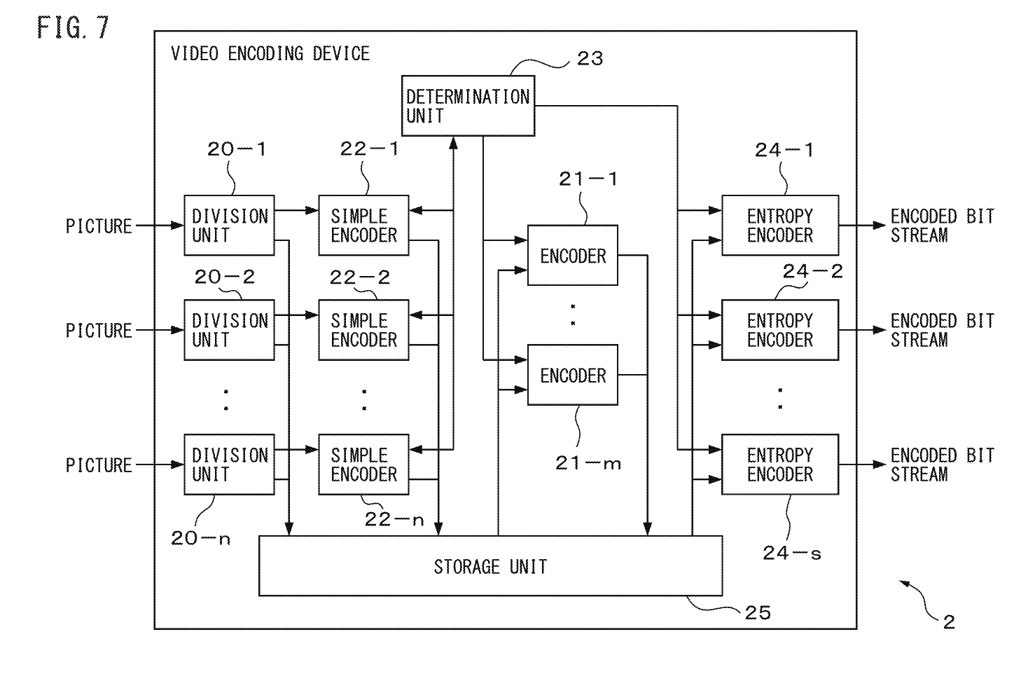

FIG. 7 is a schematic configuration diagram of the video encoding device according to this modified example. A video encoding device 2 includes multiple division units 20-1 to 20-n, one or more encoders 21-1 to 21-m, multiple simple encoders 22-1 to 22-n, a determination unit 23, multiple entropy encoders 24-1 to 24-s, and a storage unit 25. Wherein, m is an integer larger than or equal to one, and each of n and s is an integer larger than or equal to two. For example, the video encoding device 2 preferably includes simple encoders the number of which is equal to the largest value of the number of video data to be encoded in parallel. The number of blocks to be coding targets of the encoders is smaller than the number of blocks to be encoded by the simple encoders. Accordingly, the number n of the simple encoders of the video encoding device 2 is preferably larger than the number m of the encoders. With this configuration, the video encoding device 2 can improve the operation rate of each encoder, and can consequently reduce the scale of the arithmetic circuit while efficiently encoding a plurality of video data streams. The number s of the entropy encoders of the video encoding device 2 is preferably equal to the number n of the simple encoders. With this configuration, the video encoding device 2 can perform entropy encoding in parallel on the video data the number of which is the same as that of the video data at which the n simple encoders perform prediction coding in parallel.

The video encoding device 2 is mounted, for example, in a server configured to generate an image of a virtual machine to be displayed on each terminal and to perform compression coding on the image and then deliver the image to each terminal, in a system providing a VDI. In this case, the video encoding device 2 encodes the image of the virtual machine for each terminal.

Pictures of different video data are sequentially input to the multiple division units 20-1 to 20-n in the coding order. Alternatively, different pictures of the same video data may be input to the division units 20-1 to 20-n. Each of the multiple division units 20-1 to 20-n has a similar function to that of the division unit 10 of the video encoding device 1 illustrated in FIG. 1 and is configured to divide each input picture into multiple blocks. Blocks obtained by the division unit 20-k (1≦k≦n) are sequentially input to the simple encoder 22-k in the raster scan order and are stored in the storage unit 25.

Each of the multiple encoders 21-1 to 21-m has a similar function to that of the encoder 11 of the video encoding device 1. Each of the encoders 21-1 to 21-m reads the coding-target block instructed by the determination unit 23, from the storage unit 25 and performs prediction coding on the read block by employing the coding mode corresponding to the smallest coding cost among the multiple coding modes. Each of the encoders 21-1 to 21-m then stores encoded data of the block in the storage unit 25. Each of the encoders 21-1 to 21-m notifies the determination unit 23 that coding is completed every time generation of encoded data of a block is completed.

Each of the multiple simple encoders 22-1 to 22-n has a similar function to that of the simple encoder 12 of the video encoding device 1. Each of the simple encoders 22-1 to 22-n performs prediction coding on an input block by employing a coding mode selected with reference to a reference range smaller than that of each of the encoders 21-1 to 21-m. Each of the simple encoders 22-1 to 22-n stores encoded data of the block in the storage unit 25.

The determination unit 23 has a similar function to that of the determination unit 13 of the video encoding device 1. Every time the determination unit 23 receives a coding cost from one of the simple encoders 22-1 to 22-n, the determination unit 23 determines whether the block encoded by the simple encoder is to be a coding target of the encoders, on the basis of the received coding cost. The determination unit 23 instructs one of the encoders not performing coding among the encoders 21-1 to 21-m, to encode a block which is determined to be a target of the encoders.

When the number of input video data streams is large and exceeds the throughput of the encoders 21-1 to 21-m, the determination unit 23 does not need to determine each block included in the picture of any of the video data, to be a target for coding by the encoders 21-1 to 21-m. For example, when the number of blocks determined to be processing targets of the encoders 21-1 to 21-m within a certain time period immediately previous to the determination in the video data is equal to or larger than predetermined number, the determination unit 23 does not determine the blocks included in the picture of any of the video data to be processing targets of any of the encoders. With this configuration, the determination unit 23 can prevent an over flow from occurring in any of the encoders 21-1 to 21-m.

Each of the multiple entropy encoders 24-1 to 24-s has a similar function as that of the entropy encoder 14 of the video encoding device 1. Each of the entropy encoders 24-1 to 24-s performs entropy encoding on encoded data of the picture of any of the video data being encoded.

The storage unit 25 has a similar function to that of the storage unit 15 of the video encoding device 1. The storage unit 25 stores pictures, encoded data of each block of each picture, locally-decoded pictures, and the like of coding-target video data.

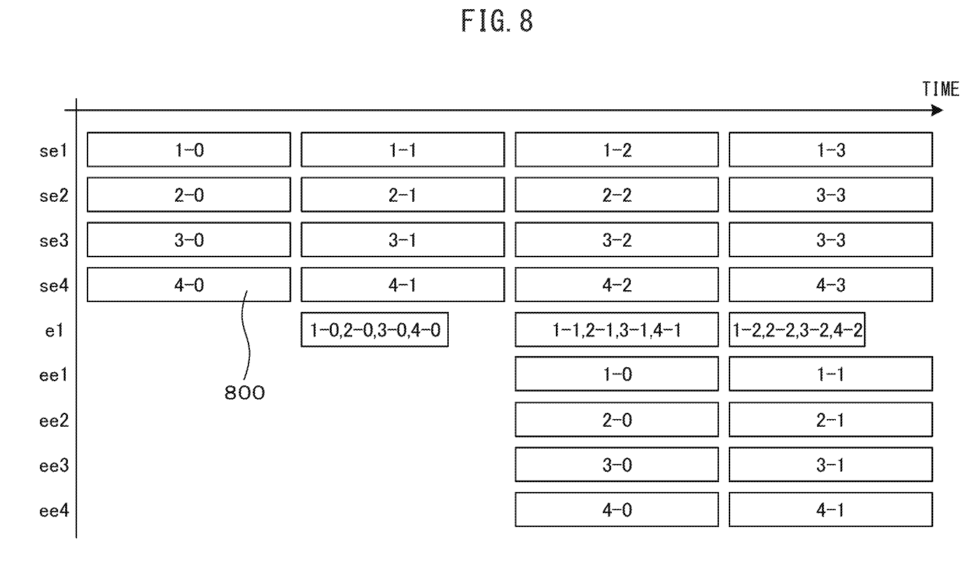

FIG. 8 is a diagram illustrating an example of a timing chart representing target pictures to be processed by each unit when the video encoding device 2 encodes a plurality of video data streams in parallel. In this example, it is assumed that n=s=4 and m=1. In addition, the video encoding device 2 is assumed to encode four video data streams in parallel. In FIG. 8, the horizontal axis represents time. In addition, se1 to se4 of the vertical axis denote the respective simple encoders 22-1 to 22-4. Moreover, e1 denotes the encoder 21-1. Further, ee1 to ee4 denote the respective entropy encoders 24-1 to 24-4. Each block 800 represents a time period for coding of a corresponding picture by any of the encoders, simple encoders, and entropy encoders. Regarding (X-Y) depicted in each block 800, X denotes the input/output system of the corresponding video data, and Y denotes the picture number. For example, (1-2) represents the second picture included in the video data of the first input/output system.

In this example, four video data streams are encoded in parallel by the use of different simple encoders and entropy encoders. In contrast, an encoder is used for the four video data streams in common. The encoder encodes the blocks included in the picture immediately previous to the picture each of the simple encoders is encoding. Similarly, each entropy encoder performs entropy encoding on the encoded data of each block included in the picture immediately previous to the picture that the corresponding encoder is encoding.

The video encoding device according to the above-described embodiment or modified example may encode video data in accordance with a video coding standard other than HEVC. For example, the video encoding device may encode video data in accordance with H.264. In this case, each division unit divides a picture included in video data into blocks with 16 pixels by 16 pixels, for example. Moreover, no simple encoder or encoder need perform deblocking filtering in order to prevent transmission of an influence of deblocking filtering to the multiple blocks. In this case, the encoder preferably selects a coding mode to employ so that block noise is not to occur around the boundaries between any block encoded by the simple encoder and any block encoded by the encoder. To enable this, the encoder may employ only coding modes included, for example, in the range in which a block boundary strength bS defining the strength of deblocking filter is zero, for the boundaries between any block encoded by the simple encoder and any block encoded by the encoder.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A video encoding device which encodes a picture included in a video, the video encoding device comprising:
a divider configured to divide the picture into a plurality of blocks;
a first encoder configured to calculate, for each of the plurality of blocks, an evaluation value representing amount of a prediction error in the predictive coding based on any of at least one first coding mode on which a first reference range in a reference picture previous to the picture in the coding order or an encoded reference area in the picture is referenced, and perform predictive coding on any block of the plurality of blocks according to any of the at least one first coding mode to calculate encoded data of the block;
a second encoder configured to perform predictive coding on any block of the plurality of blocks according to any of the at least one second coding mode on which a second reference range in the reference picture or the reference area is referenced, to calculate encoded data of the block, the second reference range being larger than the first reference range and;
a determinator configured to determine a block on which predictive coding is to be performed by the second encoder among the plurality of blocks, based on the evaluation value for each of the plurality of blocks; and
an entropy encoder configured to perform entropy encoding on the encoded data of each of the plurality of blocks.

2. The video encoding device according to claim 1, wherein
each of the at least one first coding mode and each of the at least one second coding mode include an inter-prediction coding mode which performs predictive coding on an arbitrary block among the plurality of blocks with reference to the reference picture, and
the first encoder sets the first reference range in the reference picture to be narrower than the second reference range in the reference picture.

3. The video encoding device according to claim 2, wherein
the at least one first coding mode includes an intra-prediction coding mode which performs predictive coding on an arbitrary block among the plurality of blocks with reference to the reference area, and
the first encoder sets the first reference range in the reference area such that the first reference range does not include a block on which the second encoder performs predictive coding among the plurality of blocks.

4. The video encoding device according to claim 3, wherein
when both the inter-prediction coding mode and the intra-prediction coding mode are usable to the picture, the first encoder performs predictive coding on each block which is not encoded by the second encoder among the plurality of blocks according to the inter-prediction coding mode, and the second encoder selects, for each block that is determined to be encoded by the second encoder among the plurality of blocks, a coding mode to be applied to the block from the inter-prediction coding mode and the intra-prediction coding mode.

5. The video encoding device according to claim 2, wherein
the at least one second coding mode includes an intra-prediction coding mode which performs predictive coding on an arbitrary block among the plurality of blocks with reference to the reference area, and the at least one first coding mode does not include the intra-prediction coding mode.

6. The video encoding device according to claim 1, wherein
the second encoder performs deblocking filtering on a part including a boundary between a block on which the second encoder performs predictive coding among the plurality of blocks and a block on which the first encoder performs predictive coding among the plurality of blocks.

7. The video encoding device according to claim 1, wherein
the determinator determines the block whose evaluation value is larger than a predetermined threshold value as the block on which predictive coding is to be performed by the second encoder, among the plurality of blocks.

8. The video encoding device according to claim 1, wherein
the first encoder generates the encoded data by orthogonal transforming on a prediction error obtained by predictive coding on a block not encoded by the second encoder among the plurality of blocks to calculate orthogonal-transform coefficients having a frequency within a predetermined frequency range, setting orthogonal-transform coefficients having a frequency not included in the predetermined frequency range to be a predetermined value, and quantizing the orthogonal-transform coefficient for each frequency.

9. The video encoding device according to claim 2, wherein
the entropy encoder obtains a prediction vector for a motion vector indicating an area on the reference picture referred to at the time of calculating the prediction error for a block to which the inter-prediction coding mode is applied among the plurality of blocks, and performs entropy encoding on an index indicating the prediction vector.

10. A video encoding method which encodes a picture included in a video, the video encoding method comprising:
dividing the picture into a plurality of blocks;
calculating, for each of the plurality of blocks, an evaluation value representing amount of a prediction error at the time of calculating encoded data by a first encoder which calculates the encoded data of the block by performing predictive coding on the block based on any of at least one first coding mode on which a first reference range in a reference picture previous to the picture in the coding order or an encoded reference area in the picture is referenced;
determining a block on which predictive coding is to be applied by a second encoder which performs predictive coding on a block among the plurality of blocks according to any of the at least one second coding mode on which a second reference range in the reference picture or the reference area is referenced, to calculate encoded data of the block, the second reference range being larger than the first reference range, on the basis of the evaluation value for each of the plurality of blocks;
performing predictive coding on a block which is not encoded by the second encoder among the plurality of blocks by the first encoder to calculate the encoded data of the block;
performing predictive coding on a block that is determined to be encoded by the second encoder among the plurality of blocks by the second encoder to calculate the encoded data of the block; and
performing entropy encoding on the encoded data of each of the plurality of blocks.

11. The video encoding method according to claim 10, wherein
each of the at least one first coding mode and each of the at least one second coding mode include an inter-prediction coding mode which performs predictive coding on an arbitrary block among the plurality of blocks with reference to the reference picture, and the video encoding method further comprising:
setting, by the first encoder, the first reference range in the reference picture to be narrower than the second reference range in the reference picture.

12. The video encoding method according to claim 11, wherein
the at least one first coding mode includes an intra-prediction coding mode which performs predictive coding on an arbitrary block among the plurality of blocks with reference to the reference area, and the video encoding method further comprising:
setting, by the first encoder, the first reference range in the reference area such that the first reference range does not include a block on which the second encoder performs predictive coding among the plurality of blocks.

13. The video encoding method according to claim 12, wherein
when both the inter-prediction coding mode and the intra-prediction coding mode are usable to the picture, the performing predictive coding by the first encoder performs predictive coding on each block which is not encoded by the second encoder among the plurality of blocks according to the inter-prediction coding mode, and the performing predictive coding by the second encoder includes: selecting, for each block that is determined to be encoded by the second encoder among the plurality of blocks, a coding mode to be applied to the block from the inter-prediction coding mode and the intra-prediction coding mode.

14. The video encoding method according to claim 11, wherein
the at least one second coding mode includes an intra-prediction coding mode which performs predictive coding on an arbitrary block among the plurality of blocks with reference to the reference area, and the at least one first coding mode does not include the intra-prediction coding mode.

15. The video encoding method according to claim 10, wherein
the performing predictive coding by the second encoder includes: deblocking filtering on a part including a boundary between a block on which the second encoder performs predictive coding among the plurality of blocks and a block on which the first encoder performs predictive coding among the plurality of blocks.

16. The video encoding method according to claim 10, wherein
the determining the block on which predictive coding is to be applied by the second encoder determines the block whose evaluation value is larger than a predetermined threshold value as the block on which predictive coding is to be performed by the second encoder, among the plurality of blocks.

17. The video encoding method according to claim 10, wherein
the performing predictive coding by the first encoder generates the encoded data by orthogonal transforming on a prediction error obtained by predictive coding on a block not encoded by the second encoder among the plurality of blocks to calculate orthogonal-transform coefficients having a frequency within a predetermined frequency range, setting orthogonal-transform coefficients having a frequency not included in the predetermined frequency range to be a predetermined value, and quantizing the orthogonal-transform coefficient for each frequency.

18. The video encoding method according to claim 11, wherein
the performing entropy encoding includes: obtaining a prediction vector for a motion vector indicating an area on the reference picture referred to at the time of calculating the prediction error for a block to which the inter-prediction coding mode is applied among the plurality of blocks, and performing entropy encoding on an index indicating the prediction vector.

19. A video encoding device which encodes a picture included in a video, the video encoding device comprising:
a processor configured to:
divide the picture into a plurality of blocks;
calculate, for each of the plurality of blocks, an evaluation value representing amount of a prediction error in the predictive coding based on any of at least one first coding mode on which a first reference range in a reference picture previous to the picture in the coding order or an encoded reference area in the picture is referenced;
perform predictive coding on any block of the plurality of blocks according to any of the at least one first coding mode to calculate encoded data of the block;
perform predictive coding on any block of the plurality of blocks according to any of the at least one second coding mode on which a second reference range in the reference picture or the reference area is referenced, to calculate encoded data of the block, the second reference range being larger than the first reference range and;
determine a block on which predictive coding is to be performed by the second encoder among the plurality of blocks, based on the evaluation value for each of the plurality of blocks; and
perform entropy encoding on the encoded data of each of the plurality of blocks.
